(19) United States
(12) Patent Application Publication
(10) Pub. No.: US 2025/0117663 A1
(43) Pub. Date: Apr. 10, 2025

(54) GLOBAL ENTITY MATCHING MODEL WITH CONTINUOUS PERFORMANCE ENHANCEMENT USING LARGE LANGUAGE MODELS

(71) Applicant: SAP SE, Walldorf (DE)

(72) Inventors: Rajesh Vellore Arumugam, Singapore (SG); Donglin Ruan, Singapore (SG); Matthias Frank, Heidelberg (DE); Yi Quan Zhou, Singapore (SG)

(21) Appl. No.: 18/480,635

(22) Filed: Oct. 4, 2023

(51) Int. Cl. G06N 3/0895

(52) U.S. Cl. CPC G06N 3/0895

(57) ABSTRACT

Methods, systems, and computer-readable storage media for training a global matching ML model using a set of enterprise data associated with a set of enterprises, receiving a subset of enterprise data associated with an enterprise that is absent from the set of enterprises, fine tuning the global matching ML model using the subset of enterprise data to provide a fine-tuned matching ML model. deploying the fine-tuned matching ML model for inference, receiving feedback to one or more inference results generated by the fine-tuned matching ML model, receiving synthetic data from a LLM system in response to at least a portion of the feedback, and fine tuning one or more of the global matching ML model and the fine-tuned ML model using the synthetic data.

### BACKGROUND

Enterprises continuously seek to improve and gain efficiencies in their operations. To this end, enterprises employ software systems to support execution of operations. Enterprises have moved toward so-called intelligent enterprise, which includes automating tasks executed in support of enterprise operations using machine learning (ML) systems. For example, one or more ML models are each trained to perform some task based on training data. Trained ML models are deployed, each receiving input (e.g., a computer-readable document) and providing output (e.g., classification of the computer-readable document) in execution of a task (e.g., document classification task). ML systems can be used in a variety of problem spaces. An example problem space includes autonomous systems that are tasked with matching items of one entity to items of another entity. Examples include, without limitation, matching questions to answers, people to products, bank statements to invoices, and bank statements to customer accounts.

### SUMMARY

Implementations of the present disclosure are directed to machine learning (ML) models for matching entities represented in computer-readable documents. More particularly, implementations of the present disclosure are directed to using large language models (LLMs) to enhance performance of entity matching ML models.

In some implementations, actions include training a global matching ML model using a set of enterprise data associated with a set of enterprises, receiving a subset of enterprise data associated with an enterprise that is absent from the set of enterprises, fine tuning the global matching ML model using the subset of enterprise data to provide a fine-tuned matching ML model. deploying the fine-tuned matching ML model for inference, receiving feedback to one or more inference results generated by the fine-tuned matching ML model, receiving synthetic data from a LLM system in response to at least a portion of the feedback, and fine tuning one or more of the global matching ML model and the fine-tuned matching ML model using the synthetic data. Other implementations of this aspect include corresponding systems, apparatus, and computer programs, configured to perform the actions of the methods, encoded on computer storage devices.

These and other implementations can each optionally include one or more of the following features: fine tuning of the global matching ML model using the subset of enterprise data to provide a fine-tuned matching ML model includes using a dynamic metadata configuration by merging metadata of enterprise data in the set of enterprise data with metadata of enterprise data in the subset of enterprise data; enterprise data in the subset of enterprise data includes a set of match tuples, each match tuple indicating a query entity, a target entity, and a match type; the feedback includes one or more corrections to predictions generated by the fine-tuned matching ML model; receiving synthetic data from a LLM system in response to at least a portion of the feedback is in response to a prompt input to a LLM of the LLM system; the synthetic data includes match tuples that are absent from the subset of enterprise data; and actions further include deploying the global matching ML model for inference by one or more of the enterprises in the subset of enterprises.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts portions of example electronic documents.

FIG. 4 depicts an example conceptual architecture in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to machine learning (ML) models for matching entities represented in computer-readable documents. More particularly, implementations of the present disclosure are directed to using large language models (LLMs) to enhance performance of entity matching ML models.

Implementations can include actions of training a global matching ML model using a set of enterprise data associated with a set of enterprises, receiving a subset of enterprise data associated with an enterprise that is absent from the set of enterprises, fine tuning the global matching ML model using the subset of enterprise data to provide a fine-tuned matching ML model. deploying the fine-tuned matching ML model for inference, receiving feedback to one or more inference results generated by the fine-tuned matching ML model, receiving synthetic data from a LLM system in response to at least a portion of the feedback, and fine tuning one or more of the global matching ML model and the fine-tuned matching ML model using the synthetic data.

Implementations of the present disclosure are described in further detail herein with reference to an example problems space of matching entities represented by computer-readable records (electronic documents). It is contemplated, however, that implementations of the present disclosure can be realized in any appropriate problem space.

Matching entities represented by computer-readable records appears in many contexts. Example contexts can include matching product catalogs, deduplicating a materials database, and matching incoming payments from a bank statement table to open invoices. Implementations of the present disclosure are described in further detail with reference to an example use case within the example problem space, the example use case including the domain of finance and matching bank statements to invoices. More particularly, implementations of the present disclosure are described with reference to the problem of, given a bank statement (e.g., a computer-readable electronic document recording data representative of a bank statement), enabling an autonomous system using a ML model to determine one or more invoices (e.g., computer-readable electronic documents recording data representative of one or more invoices) that are represented in the bank statement. It is contemplated, however, that implementations of the present disclosure can be realized in any appropriate use case within the example problem space.

To provide context for implementations of the present disclosure, and as introduced above, enterprises continuously seek to improve and gain efficiencies in their operations. To this end, enterprises employ software systems to support execution of operations. So-called intelligent enterprise includes automating tasks executed in support of enterprise operations using ML systems. For example, one or more ML models are each trained to perform some task based on training data. Trained ML models are deployed, each receiving input (e.g., a computer-readable document) and providing output (e.g., classification of the computer-readable document) in execution of a task (e.g., document classification task). ML systems can be used in a variety of problem spaces. An example problem space includes autonomous systems that are tasked with matching items of one entity to items of another entity. Examples include, without limitation, matching questions to answers, people to products, bank statement line items to invoices, and bank statement line items to customer accounts.

Technologies related to ML have been widely applied in various fields. For example, ML-based decision systems can be used to make decisions on subsequent tasks. With reference to the example use case, an ML-based decision system can be used to determine matches between bank statement line items and invoices. For example, invoices can be automatically cleared in an accounting system by matching invoices to one or more line items in bank statements. In general, an output of a ML-based decision system can be referred to as a prediction or an inference result.

However, generating a ML model is a non-trivial task that requires a significant amount of training data and consumes a significant amount of computing resources (e.g., processors, memory) to train the ML model. In some scenarios, instead of individualized matching ML models, one for each enterprise of multiple, disparate enterprises, a global matching ML model is provisioned for all of the multiple, disparate enterprises. For example, enterprise data provided from each of the enterprises can be used to train the global matching ML model. However, if another (new) enterprise seeks to use the global matching ML model in its operations, the performance of the global matching ML model will be poor for that enterprise. This is because the global matching ML model was not trained on enterprise data of that enterprise. In traditional approaches, in order to account for this enterprise, the global matching ML model is retrained using enterprise data of all of the enterprises including the new enterprise. This is a time- and resource-intensive process for retraining the global matching ML model to onboard new enterprises.

As another challenge, if an enterprise has limited data available that is representative of its operations and can be used as training data, the global matching ML model may not perform well or may be overfitting to the enterprise-specific data. This also prevents the global matching ML model from being able to generalize to new situations that are not represented in the limited training data. Furthermore, after training and deployment for inference, ML models need ongoing maintenance and updates to stay current and relevant, which can be time- and resource-expensive, particularly in provisioning a global matching ML model for numerous enterprises.

In view of the above context, implementations of the present disclosure are directed to providing a global matching ML model that is generic to multiple enterprises and, for each enterprise seeking to leverage the global matching ML model, but did not have enterprise data used in training the global matching ML model, providing a fine-tuned matching ML model by fine-tuning of the global matching ML model to the enterprise. In some implementations, fine-tuning is performed using a subset of enterprise data of the enterprise and/or synthetic data that is generated by a LLM system based on user feedback.

More particularly, and as described in further detail herein, enterprise data of a set of enterprises is merged into a centralized dataset. In the context of implementations of the present disclosure, the enterprise data includes, for each enterprise, query entity and target entity pairs, each representing a target entity that is matched to a query entity. In some implementations, the centralized dataset is used to train a global matching ML model that is generic to the enterprises in the set of enterprises. The global matching ML model can be used by each enterprise in the set of enterprises to provide inferences (predictions) that can be used in their respective enterprise operations.

In some implementations, an enterprise that was not included in the set of enterprises can seek to use the global matching ML model. That is, an enterprise that did not have its enterprise data used to train the global matching ML model, referred to as a new enterprise herein, can seek to use the global matching ML model. In accordance with implementations of the present disclosure, a subset of enterprise data that is specific to the enterprise is used to fine-tune the global matching ML model to provide a fine-tuned matching ML model. In some examples, fine-tuning is achieved utilizing a dynamic metadata configuration.

In some implementations, the fine-tuned matching ML model is used by the enterprise for inference and a user (e.g., an agent of the enterprise) can provide feedback on the inference results. For example, the feedback can include corrections to incorrect predictions. In accordance with implementations of the present disclosure, the feedback is used to input to prompt to a LLM system, which generates a result that is responsive to the prompt. The result is used as synthetic data that is used to further fine-tune the fine-tuned matching ML model to enhance the performance (e.g., accuracy) thereof.

In general, a LLM can be described as an advanced type of language model that is trained using deep learning techniques on massive amounts of text data. LLMs can generate human-like text and can perform various natural language processing (NLP) tasks (e.g., translation, question answering). The term LLM refers to models that use deep learning techniques and have many parameters, which can range from millions to billions. LLMs can capture complex patterns in language and produce text that is often indistinguishable from that written by humans. This data is processed through a deep learning architecture, such as a recurrent neural network (RNN) or a transformer model.

Implementations of the present disclosure are described in further detail herein with reference to an example application that leverages one or more ML models to provide functionality (referred to herein as a ML application). The example application includes SAP Cash Application (CashApp) provided by SAP SE of Walldorf, Germany. CashApp leverages ML models that are trained using a ML framework (e.g., SAP AI Core) to learn accounting activities and to capture rich detail of customer and country-specific behavior.

An example accounting activity can include matching payments indicated in a bank statement to invoices for clearing of the invoices. For example, using an enterprise system (e.g., SAP S/4 HANA), incoming payment information (e.g., recorded in computer-readable bank statements) and open invoice information are passed to a matching engine, and, during inference, one or more ML models predict matches between line items of a bank statement and invoices. In some examples, matched invoices are either automatically cleared (auto-clearing) or suggested for review by a user (e.g., accounts receivable). Although CashApp is referred to herein for purposes of illustrating implementations of the present disclosure, it is contemplated that implementations of the present disclosure can be realized with any appropriate application that leverages one or more ML models.

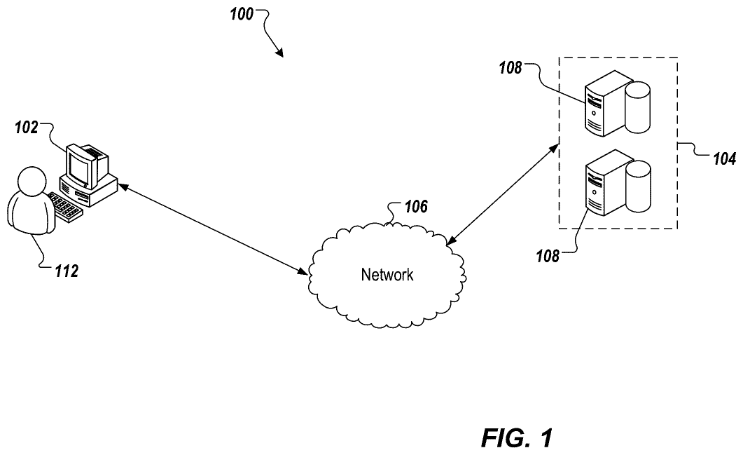

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a ML-based decision system that predicts matches between entities (e.g., CashApp, referenced by way of example herein). Also in accordance with implementations of the present disclosure, the server system 104 can host a ML model system that includes a fine-tuning system, as described in further detail herein.

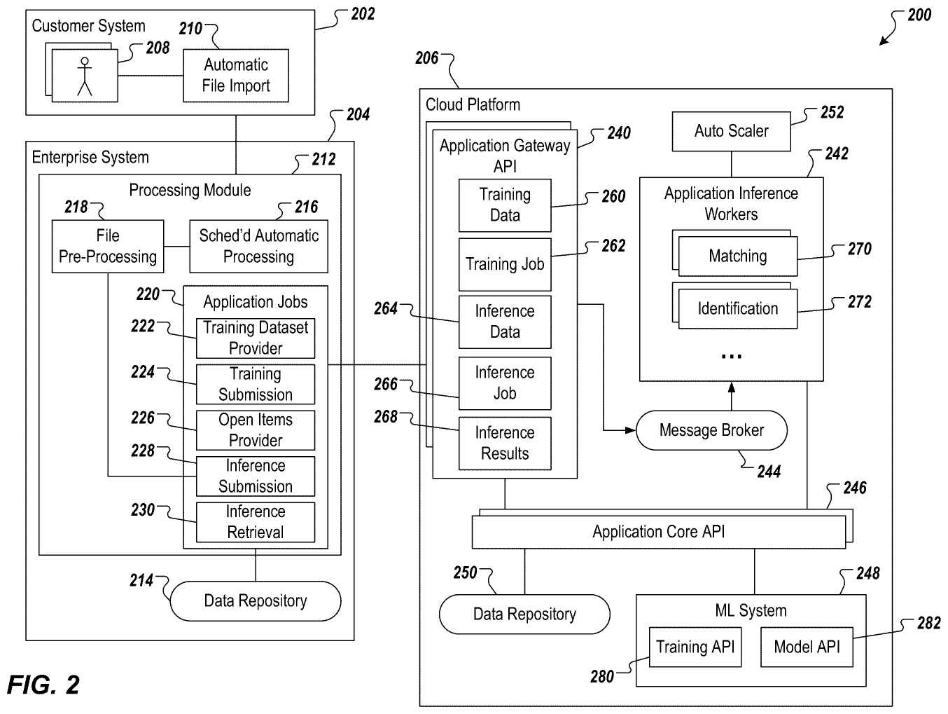

FIG. 2 depicts an example conceptual architecture 200 in accordance with implementations of the present disclosure. In the depicted example, the conceptual architecture 200 includes a customer system 202, an enterprise system 204 (e.g., SAP S/4 HANA) and a cloud platform 206 (e.g., SAP Cloud Platform (Cloud Foundry)). As described in further detail herein, the enterprise system 204 and the cloud platform 206 facilitate one or more ML applications that leverage ML models to provide functionality for one or more enterprises. In some examples, each enterprise interacts with the ML application(s) through a respective customer system 202. For purposes of illustration, and without limitation, the conceptual architecture 200 is discussed in further detail with reference to CashApp, introduced above. However, implementations of the present disclosure can be realized with any appropriate ML application.

In the example of FIG. 2, the customer system 202 includes one or more client devices 208 and a file import module 210. In some examples, a user (e.g., an employee of the customer) interacts with a client device 208 to import one or more data files to the enterprise system 204 for processing by a ML application. For example, and in the context of CashApp, an invoice data file and a bank statement data file can be imported to the enterprise system 204 from the customer system 202. In some examples, the invoice data file includes data representative of one or more invoices issued by the customer, and the bank statement data file includes data representative of one or more payments received by the customer. As another example, the one or more data files can include training data files that provide customer-specific training data for training of one or more ML models for the customer.

In the example of FIG. 2, the enterprise system 204 includes a processing module 212 and a data repository 214. In the context of CashApp, the processing module 212 can include a finance—accounts receivable module. The processing module 212 includes a scheduled automatic processing module 216, a file pre-processing module 218, and an applications job module 220. In some examples, the scheduled automatic processing module 216 receives data files from the customer system 202 and schedules the data files for processing in one or more application jobs. The data files are pre-processed by the file pre-processing module 218 for consumption by the processing module 212.

Example application jobs can include, without limitation, training jobs and inference jobs. In some examples, a training job includes training of a ML model using a training file (e.g., that records customer-specific training data). In some examples, an inference job includes using a ML model to provide a prediction, also referred to herein as an inference result. In the context of CashApp, the training data can include invoice to bank statement line item matches as examples provided by a customer, which training data is used to train a ML model to predict invoice to bank statement matches. Also in the context of CashApp, the data files can include an invoice data file and a bank statement data file that are ingested by a ML model to predict matches between invoices and bank statements in an inference process.

With continued reference to FIG. 2, the application jobs module 220 includes a training dataset provider sub-module 222, a training submission sub-module 224, an open items provider sub-module 226, an inference submission sub-module 228, and an inference retrieval sub-module 230. In some examples, for a training job, the training dataset provider sub-module 222 and the training submission sub-module 224 function to request a training job from and provide training data to the cloud platform 206. In some examples, for an inference job, the training dataset provider sub-module 222 and the training submission sub-module 224 function to request a training job from and provide training data to the cloud platform 206.

In some implementations, the cloud platform 206 hosts at least a portion of the ML application (e.g., CashApp) to execute one or more jobs (e.g., training job, inference job). In the example of FIG. 2, the cloud platform 206 includes one or more application gateway application programming interfaces (APIs) 240, application inference workers 242 (e.g., matching worker 270, identification worker 272), a message broker 244, one or more application core APIs 246, a ML system 248, a data repository 250, and an auto-scaler 252. In some examples, the application gateway API 240 receives job requests from and provides job results to the enterprise system 204 (e.g., over a REST/HTTP [oAuth] connection). For example, the application gateway API 240 can receive training data 260 for a training job 262 that is executed by the ML system 248. As another example, the application gateway API 240 can receive inference data 264 (e.g., invoice data, bank statement data) for an inference job 266 that is executed by the application inference workers 242, which provide inference results 268 (e.g., predictions).

In some examples, the enterprise system 204 can request the training job 262 to train one or more ML models using the training data 260. In response, the application gateway API 240 sends a training request to the ML system 248 through the application core API 246. By way of non-limiting example, the ML system 248 can be provided as SAP AI Core. In the depicted example, the ML system 248 includes a training API 280 and a model API 282. The ML system 248 trains a ML model using the training data. In some examples, the ML model is accessible for inference jobs through the model API 282.

In some examples, the enterprise system 204 can request the inference job 266 to provide the inference results 268, which includes a set of predictions from one or more ML models. In some examples, the application gateway API 240 sends an inference request, including the inference data 264, to the application inference workers 242 through the message broker 244. An appropriate inference worker of the application inference workers 242 handles the inference request. In the example context of matching invoices to bank statements, the matching worker 270 transmits an inference request to the ML system 248 through the application core API 246. The ML system 248 accesses the appropriate ML model (e.g., the ML model that is specific to the customer and that is used for matching invoices to bank statements), which generates the set of predictions. The set of predictions are provided back to the inference worker (e.g., the matching worker 270) and are provided back to the enterprise system 204 through the application gateway API 240 as the inference results 268. In some examples, the auto-scaler 252 functions to scale the inference workers up/down depending on the number of inference jobs submitted to the cloud platform 206.

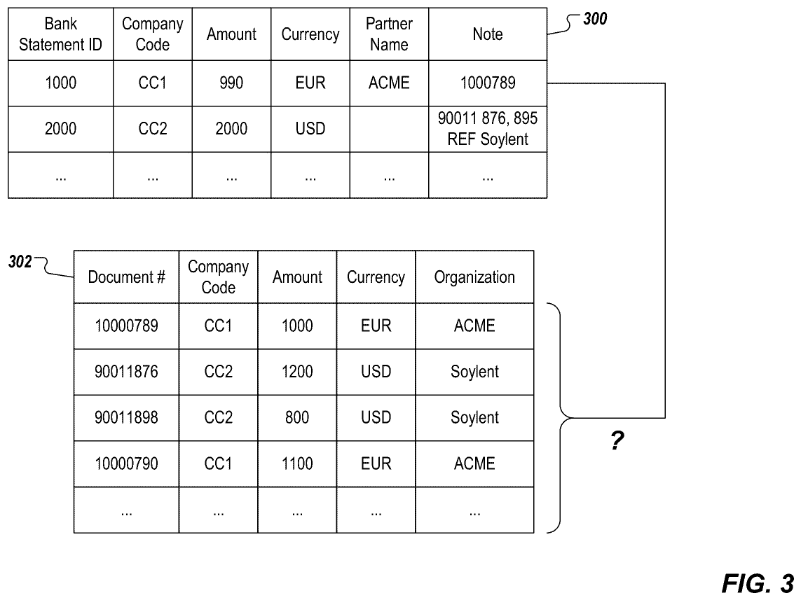

In the example context, FIG. 3 depicts portions of example electronic documents. In the example of FIG. 3, a first electronic document 300 includes a bank statement table that includes records representing payments received, and a second electronic document 302 includes an invoice table that includes invoice records respectively representing invoices that had been issued. In the example context, each bank statement record is to be matched to one or more invoice records. Accordingly, the first electronic document 300 and the second electronic document 302 are processed using one or more ML models that provide predictions regarding matches between a bank statement record (entity) and one or more invoice records (entity/-ies) (e.g., using CashApp, as described above).

To achieve this, a ML model (matching ML model) is provided as a classifier that is trained to predict entity pairs to a fixed set of class labels (\vec{l}) (e.g., l₀, l₁, l₂). For example, the set of class labels (\vec{l}) can include ‘no match’ (l₀), ‘single match’ (l₁), and ‘multi match’ (l₂). In some examples, the ML model is provided as a function ƒ that maps a query entity (\vec{a}) and a target entity (\vec{b}) into a vector of probabilities (\vec{p}) (also called ‘confidences’ in the deep learning context) for the labels in the set of class labels. This can be represented as:

$$f ( \vec{a} , \vec{b} ) = ( \begin{matrix}{p}_{0} \\ {p}_{1} \\ {p}_{2}\end{matrix} )$$

where \vec{p}={p₀,p₁,p₂}. In some examples, p₀ is a prediction probability (also referred to herein as confidence c) of the item pair \vec{a}, \vec{b} belonging to a first class (e.g., no match), p₁ is a prediction probability of the item pair \vec{a}, \vec{b} belonging to a second class (e.g., single match), and p₂ is a prediction probability of the item pair \vec{a}, \vec{b} belonging to a third class (e.g., multi match).

Here, p₀, p₁, and p₂ can be provided as numerical values indicating a likelihood (confidence) that the item pair \vec{a}, \vec{b} belongs to a respective class. In some examples, the ML model can assign a class to the item pair \vec{a}, \vec{b} based on the values of p₀, p₁, and p₂. In some examples, the ML model can assign the class corresponding to the highest value of p₀, p₁, and p₂. For example, for an entity pair \vec{a}, \vec{b}, the ML model can provide that p₀=0.13, p₁=0.98, and p₂=0.07. Consequently, the ML model can assign the class ‘single match’ (l₁) to the item pair \vec{a}, \vec{b}.

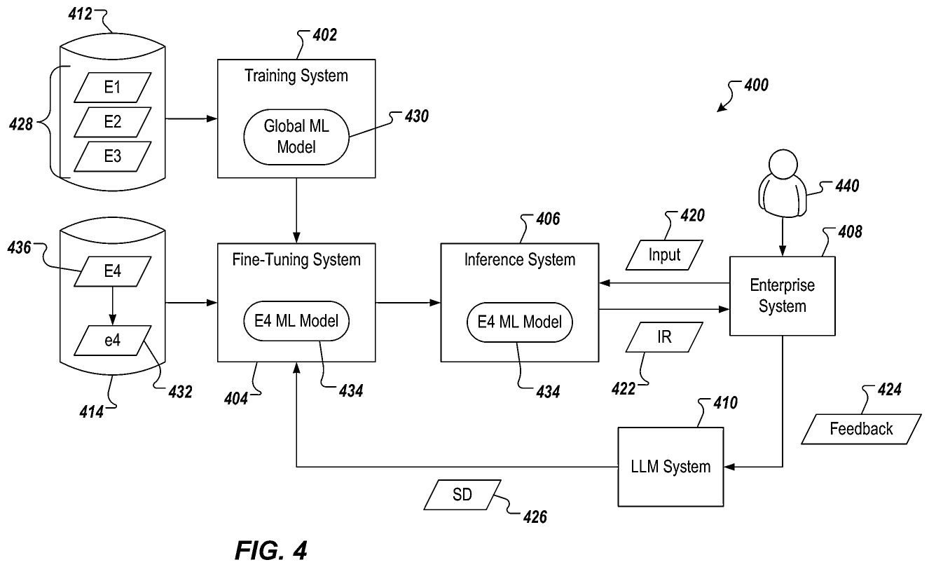

FIG. 4 depicts an example conceptual architecture 400 in accordance with implementations of the present disclosure. In the example of FIG. 4, the conceptual architecture 400 includes a training system 402, a fine-tuning system 404, an inference system 406, an enterprise system 408, and a LLM system 410. In the example of FIG. 4, the conceptual architecture 400 also includes a training datastore 412 and a fine-tuning datastore 414. As described in further detail herein, input 420 is provided to the inference system 406, which generates an inference result (IR) 422 that is responsive to the input 420. In some examples, feedback 424 that is responsive to the inference result 422 can be provided to the LLM system 410, which generates synthetic data (SD) 426 that is responsive to the feedback 424.

In some implementations, the training system 402 trains a global matching ML model 430 using a set of enterprise data 428 stored in the training datastore 412. In some examples, the set of enterprise data 428 is provided from a set of enterprises that includes a first enterprise (E1), a second enterprise (E2), and a third enterprise (E3). In the context of implementations of the present disclosure, the enterprise data can include query entity, target entity, and match type tuples, each tuple representing a target entity that is matched to a query entity with a respective match type for the respective enterprises. Each enterprise's data is uniformly represented in the training data with all column values of query, target, and matching relation (e.g., single, multi, none).

In general, a ML model, such as the global matching ML model 430, can be iteratively trained, where, during an iteration, one or more parameters of the ML model are adjusted, and an output is generated based on the training data. For each iteration, a loss value is determined based on a loss function. The loss value represents a degree of accuracy of the output of the ML model. The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration of training. In some instances, this process is repeated until the loss value meets the expected value.

In some examples, the global matching ML model 430 can be described as being generic to the set of enterprises (e.g., E1, E2, E3), whose enterprise data was used to train the global matching ML model 430. That is, the global matching ML model 430 is not specific to any single enterprise in the set of enterprises. In some examples, the global matching ML model 430 can be deployed for inference for one or more of the enterprises in the set of enterprises. For example, and although not depicted in FIG. 4, the global matching ML model 430 can be deployed to the inference system 406 to execute inferences and generate inference results.

An enterprise whose data was not used to train the global matching ML model 430 can seek to use the inference system 406 to provide inference results for its enterprise operations. That is, the enterprise was not included in the set of enterprises for training of the global matching ML model 430. In the example of FIG. 4, this new enterprise is provided as a fourth enterprise (E4). Here, use of the global matching ML model 430 by the fourth enterprise would result in poor performance (e.g., accuracy), because the global matching ML model 430 was not trained on enterprise data representative of operations of the fourth enterprise. That is, the global matching ML model 430 is not able to generalize well to unseen data from new enterprises, such as the fourth enterprise.

In accordance with implementations of the present disclosure, the global matching ML model 430 is provided to the fine-tuning system 404 to be fine-tuned using a subset of enterprise data 432 to provide a fine-tuned matching ML model 434. In some examples, the subset of enterprise data 432 represents one or more enterprise operations of the fourth enterprise (e.g., query entity, target entity, and match type tuples, each tuple representing a target entity that is matched to a query entity with a respective match type for the fourth enterprise). In some implementations, the subset of enterprise data 432 is randomly selected from a set of enterprise data 436 with a predefined number of query entities and target entities selected based on their corresponding pairs.

In general, fine-tuning of a ML model, such as the global matching ML model 430, includes iterative adjustment of parameters of a trained ML model based on training data (e.g., the subset of enterprise data 432). In some examples, some layers of the ML model are frozen, such that parameters of such frozen layers are not adjusted during fine-tuning. In some examples, fine-tuning of the global matching ML model is done by using a subset of enterprise data to adapt the global matching ML model to patterns specific to the enterprise data. During fine-tuning, weights of non-frozen parameters are adjusted based on the subset of enterprise data.

In accordance with implementations of the present disclosure, fine-tuning is performed using a dynamic metadata configuration. In some examples, the dynamic metadata configuration is provided by merging metadata from the set of enterprise data 428 with metadata of the subset of enterprise data 432. For example, a text token vocabulary used for fine-tuning can be provided to include text tokens from both the set of enterprise data 428 and the subset of enterprise data 432. In this manner, training examples having tokens (e.g., words) that are absent from the set of enterprise data 428, but are included in the subset of enterprise data 432 can be accounted for. This approach helps to refine performance of the fine-tuned matching ML model 434 by adapting it to specific characteristics and requirements of the new enterprise data (e.g., the subset of enterprise data 432).

In some examples, the text token vocabulary is a mapping between a list of tokens (characters) to respective numeric values. In some examples, the list of tokens include unique tokens that are included in the training data for training of the global matching ML model. The text token vocabulary is used to convert input data containing non-numeric values (e.g., English characters) to numeric values (at time of training and inference), because inputs to the ML model can only be numeric. One example of a vocabulary is all the characters in English language (e.g., if the training data contained only English characters), punctuation characters, special characters, and so on that are preset in the training data. If the training data contained characters from other languages, for example, the corresponding unicode values will be present in the text token vocabulary. The text token vocabulary is updated or expanded during fine-tuning with any new tokens that are seen in the fine-tuning training data (the enterprise-specific subset of enterprise data).

In accordance with implementations of the present disclosure, the fine-tuned matching ML model 434 is deployed to the inference system 406 to generate inference results, which can include predicted matches between query entities and target entities. For example, the input 420 can be provided from the enterprise system 408 to the inference system 406 and can be processed through the fine-tuned matching ML model 434 to provide the IR 422. In some examples, the input 420 includes a set of query entities and a set of target entities and the IR 422 includes predicted matches between query entities and target entities (e.g., query entity, target entity, match type tuples). Table 1 provides non-limiting example inference results that can be returned for predicted matches:

TABLE 1
Example Inference Results

| Query Entity Identifier | Target Entity Identifier |
|---|---|
| 1 | 10 |
| 2 | 14 |
| 3 | 15 |
| 3 | 11 |
| 4 | 17 |

In accordance with implementations of the present disclosure, a user 440 can review the IR 422, or a portion thereof, to determine whether predicted matches are correct. For example, the enterprise system 408 can display the IR 422 to the user 440 and the user can provide feedback on correctness of predicted matches, which can be represented in the feedback 424. In some examples, each tuple includes a confidence score associated therewith, which represents a confidence that the fine-tuned matching ML model 434, which is enterprise-specific, has in the respective prediction. In some examples, if the confidence score does not exceed a threshold confidence score, the respective tuple is displayed to the user 440. If the confidence score meets or exceeds the threshold confidence score, the respective tuple is not displayed to the user 440.

As described herein, the user 440 can provide feedback indicating correctness of the inference results. Table 2 provides an example of feedback to the example inference results of Table 1:

TABLE 2
Example Feedback

| Query Entity Identifier | Target Entity Identifier | Correct |
|---|---|---|
| 1 | 10 | 10 |
| 2 | 14 | 12 |
| 3 | 15 | 13 |
| 3 | 11 | 11 |
| 4 | 17 | 17 |

In the example of Table 2, it is seen that the predicted match between 1 and 10 is correct, the match between 2 and 14 is incorrect and, instead, 2 should have been matched to 12, the match between 3 and 15 is incorrect and, instead, 3 should have been matched to 13, the match between 3 and 11 is correct (e.g., 3 is matched to both 13 and 11 as a multi-match), and the match between 4 and 17 is correct.

In accordance with implementations of the present disclosure, feedback input by the user 440 can be provided to the LLM system 410 as the feedback 424. In some examples, the feedback 424 is used to provide a prompt to a LLM executed by the LLM system 410. In some implementations, the prompt is generated based on the query and target pair that was wrongly proposed and was subsequently corrected by the user 440. In some examples, a statistical distribution is determined from structured columns of the target and is used to generate structured data. The structured data is fed to the LLM system 410, which returns an unstructured sample data mimicking the hard inference data. An example prompt can be provided as:
“Given the following list of values separated by comma, generate the missing memoline”
Debtor, Invoice, Organizationname, TransactionCurrency, Businesspartnername,memoline
0, 4567, 88234, Foo organization, SGD, Foo, /PT/SG/EI/Foo Org 88234 4567
1, 4587, 88224, Panda organization, SGD, Panda, /PT/SG/EI/Panda Org 88224 4587
3, 4547, 88334, Lion organization, SGD, Lion,
   A corresponding response from the LLM system can include:
/PT/SG/EI/Lion Org 88334 4547
   In the above example, the memoline and structured values are obtained from the query and target respectively from the wrongly (and corrected) inference data. More such data can be generated by generating structured data from the inference data distribution using existing standard statistical techniques. The memolines (unstructured) are generated by LLM using the above prompt containing the structured data.

The LLM generates a result that is responsive to the feedback 424 and the LLM system 410 outputs the result as the SD 426. The SD 426 is synthetic in that tuples included therein are not explicitly seen in either the set of enterprise data 428 or the subset of enterprise data 432. In some examples, the synthetic data is obtained from LLM using the hard inference data as explained above with the examples shown above (example response from LLM).

The SD 426 is provided to the fine-tuning system 404 for use in fine-tuning. For example, the SD 426 can be used to further fine-tune the fine-tuned matching ML model 434. As another example, another enterprise-specific matching ML model can be provided by fine-tuning the global matching ML model 430 using the subset of enterprise data 432 and the synthetic data 426.

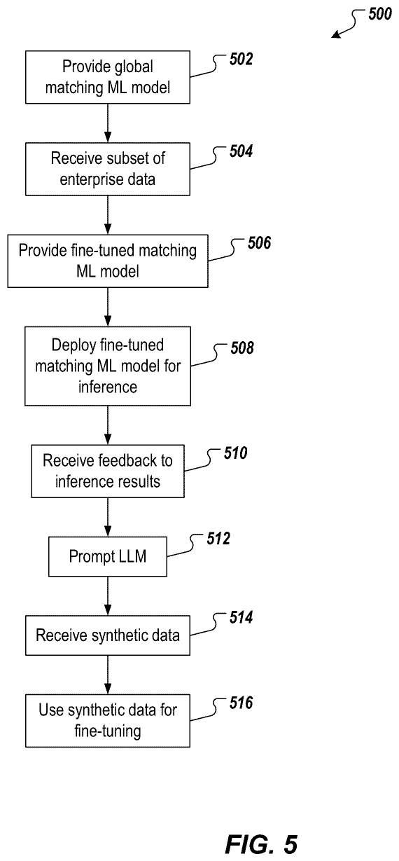

FIG. 5 depicts an example process 500 that can be executed in accordance with implementations of the present disclosure. In some examples, the example process 500 is provided using one or more computer-executable programs executed by one or more computing devices.

A global matching ML model is provided (502). For example, and as described in detail herein, the training system 402 of FIG. 4 trains the global matching ML model 430 using the set of enterprise data 428 stored in the training datastore 412. In some examples, the set of enterprise data 428 is provided from a set of enterprises that includes a first enterprise (E1), a second enterprise (E2), and a third enterprise (E3). The global matching ML model 430 is global in that it is generic to the set of enterprises (e.g., E1, E2, E3), whose enterprise data was used to train the global matching ML model 430. That is, the global matching ML model 430 is not specific to any single enterprise in the set of enterprises, whose enterprise data was used for training.

A subset of enterprise data is received (504) and fine-tuned matching ML model is provided (506). For example, and as described in detail herein, an enterprise whose data was not used to train the global matching ML model 430 can seek to use the inference system 406 to provide inference results for its enterprise operations. To this end, the global matching ML model 430 is provided to the fine-tuning system 404 to be fine-tuned using a subset of enterprise data 432 to provide a fine-tuned matching ML model 434. The fine-tuned matching ML model is deployed for inference (508). For example, and as described in detail herein, the fine-tuned matching ML model 434 is deployed to the inference system 406 to generate inference results, which can include predicted matches between query entities and target entities. For example, the input 420 can be provided from the enterprise system 408 to the inference system 406 and can be processed through the fine-tuned matching ML model 434 to provide the IR 422.

Feedback to inference results is received (510). For example, and as described in detail herein, the user 440 can review the IR 422, or a portion thereof, to determine whether predicted matches are correct. For example, the enterprise system 408 can display the IR 422 to the user 440 and the user can provide feedback on correctness of predicted matches, which can be represented in the feedback 424. A LLM is prompted (512). For example, and as described in detail herein, feedback input by the user 440 can be provided to the LLM system 410 as the feedback 424. In some examples, the feedback 424 is used to provide a prompt to a LLM executed by the LLM system 410.

Synthetic data is received (514) and the synthetic data is used for fine-tuning (516). For example, and as described in detail herein, the LLM generates a result that is responsive to the feedback 424 and the LLM system 410 outputs the result as the SD 426. The SD 426 is synthetic in that tuples included therein are not explicitly seen in either the set of enterprise data 428 or the subset of enterprise data 432. The SD 426 is provided to the fine-tuning system 404 for use in fine-tuning. For example, the SD 426 can be used to further fine-tune the fine-tuned matching ML model 434. As another example, another fine-tuned matching ML model can be provided by fine-tuning the global matching ML model 430 using the subset of enterprise data 432 and the synthetic data 426.

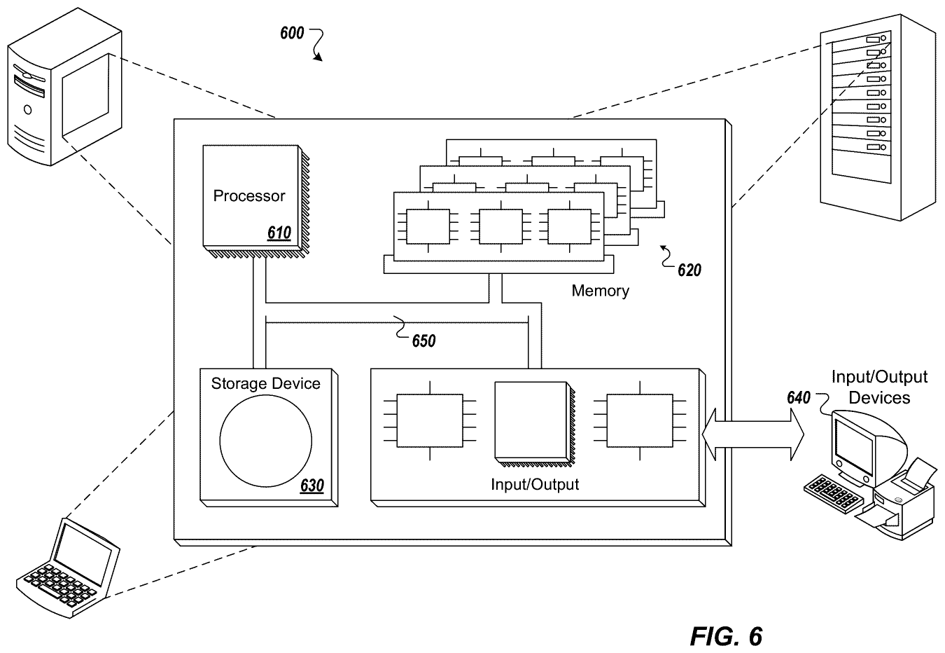

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for deploying machine learning (ML) models for inference in production to match entities represented in computer-readable documents, the method being executed by one or more processors and comprising:
training a global matching ML model using a set of enterprise data associated with a set of enterprises;
receiving a subset of enterprise data associated with an enterprise that is absent from the set of enterprises;
fine tuning the global matching ML model using the subset of enterprise data to provide a fine-tuned matching ML model;
deploying the fine-tuned matching ML model for inference;
receiving feedback to one or more inference results generated by the fine-tuned matching ML model;
receiving synthetic data from a large language model (LLM) system in response to at least a portion of the feedback; and
fine tuning one or more of the global matching ML model and the fine-tuned matching ML model using the synthetic data.

2. The method of claim 1, wherein fine tuning of the global matching ML model using the subset of enterprise data to provide a fine-tuned matching ML model comprises using a dynamic metadata configuration by merging metadata of enterprise data in the set of enterprise data with metadata of enterprise data in the subset of enterprise data.

3. The method of claim 1, wherein enterprise data in the subset of enterprise data comprises a set of match tuples, each match tuple indicating a query entity, a target entity, and a match type.

4. The method of claim 1, wherein the feedback comprises one or more corrections to predictions generated by the fine-tuned matching ML model.

5. The method of claim 1, wherein receiving synthetic data from a LLM system in response to at least a portion of the feedback is in response to a prompt input to a LLM of the LLM system.

6. The method of claim 1, wherein the synthetic data comprises match tuples that are absent from the subset of enterprise data.

7. The method of claim 1, further comprising deploying the global matching ML model for inference by one or more of the enterprises in the subset of enterprises.

8. A non-transitory computer-readable storage medium coupled to one or more processors and having instructions stored thereon which, when executed by the one or more processors, cause the one or more processors to perform operations for deploying machine learning (ML) models for inference in production to match entities represented in computer-readable documents, the operations comprising:
training a global matching ML model using a set of enterprise data associated with a set of enterprises;
receiving a subset of enterprise data associated with an enterprise that is absent from the set of enterprises;
fine tuning the global matching ML model using the subset of enterprise data to provide a fine-tuned matching ML model;
deploying the fine-tuned matching ML model for inference;
receiving feedback to one or more inference results generated by the fine-tuned matching ML model;
receiving synthetic data from a large language model (LLM) system in response to at least a portion of the feedback; and
fine tuning one or more of the global matching ML model and the fine-tuned matching ML model using the synthetic data.

9. The non-transitory computer-readable storage medium of claim 8, wherein fine tuning of the global matching ML model using the subset of enterprise data to provide a fine-tuned matching ML model comprises using a dynamic metadata configuration by merging metadata of enterprise data in the set of enterprise data with metadata of enterprise data in the subset of enterprise data.

10. The non-transitory computer-readable storage medium of claim 8, wherein enterprise data in the subset of enterprise data comprises a set of match tuples, each match tuple indicating a query entity, a target entity, and a match type.

11. The non-transitory computer-readable storage medium of claim 8, wherein the feedback comprises one or more corrections to predictions generated by the fine-tuned matching ML model.

12. The non-transitory computer-readable storage medium of claim 8, wherein receiving synthetic data from a LLM system in response to at least a portion of the feedback is in response to a prompt input to a LLM of the LLM system.

13. The non-transitory computer-readable storage medium of claim 8, wherein the synthetic data comprises match tuples that are absent from the subset of enterprise data.

14. The non-transitory computer-readable storage medium of claim 8, wherein operations further comprise deploying the global matching ML model for inference by one or more of the enterprises in the subset of enterprises.

15. A system, comprising:
a computing device; and
a computer-readable storage device coupled to the computing device and having instructions stored thereon which, when executed by the computing device, cause the computing device to perform operations for deploying machine learning (ML) models for inference in production to match entities represented in computer-readable documents, the operations comprising:
training a global matching ML model using a set of enterprise data associated with a set of enterprises;
receiving a subset of enterprise data associated with an enterprise that is absent from the set of enterprises;
fine tuning the global matching ML model using the subset of enterprise data to provide a fine-tuned matching ML model;
deploying the fine-tuned matching ML model for inference;
receiving feedback to one or more inference results generated by the fine-tuned matching ML model;
receiving synthetic data from a large language model (LLM) system in response to at least a portion of the feedback; and
fine tuning one or more of the global matching ML model and the fine-tuned matching ML model using the synthetic data.

16. The system of claim 15, wherein fine tuning of the global matching ML model using the subset of enterprise data to provide a fine-tuned matching ML model comprises using a dynamic metadata configuration by merging metadata of enterprise data in the set of enterprise data with metadata of enterprise data in the subset of enterprise data.

17. The system of claim 15, wherein enterprise data in the subset of enterprise data comprises a set of match tuples, each match tuple indicating a query entity, a target entity, and a match type.

18. The system of claim 15, wherein the feedback comprises one or more corrections to predictions generated by the fine-tuned matching ML model.

19. The system of claim 15, wherein receiving synthetic data from a LLM system in response to at least a portion of the feedback is in response to a prompt input to a LLM of the LLM system.

20. The system of claim 15, wherein the synthetic data comprises match tuples that are absent from the subset of enterprise data.
